(19) United States
(12) Patent Application Publication
(10) Pub. No.: US 2004/0071594 A1
(43) Pub. Date: Apr. 15, 2004

(54) Oral self-assessment device

(75) Inventors: Sinead Louise Malone, Bebington (GB); Michael York, Bedford (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/639,277

(22) Filed: Aug. 12, 2003

(30) Foreign Application Priority Data
Aug. 13, 2002 (EP) 02255653.4

(51) Int. Cl. G01N 31/22

(52) U.S. Cl. 422/58

(57) ABSTRACT

A device for the self-assessment of the health of the oral cavity comprising a detector and a sampler located remote from one another on a foldable support, characterised in that the sampler can be contacted with the detector by folding the support, such that a sample can be transferred from the sampler to the detector.

### BACKGROUND OF THE INVENTION

1. Field of Invention

The present invention relates to a device for the self-assessment of the health of the oral cavity comprising a detector and a sampler.

2. The Related Art

Sampling devices and assessment pads are known. These can take the form of being in vitro procedures such as in the use of Multistix®, where a sample of urine is collected externally in a container and then the Multistix® are used to test the sample in this container.

Similarly as is disclosed in U.S. Pat. No. 5,081,040 (Chandravadan) blood and faecal samples can be tested through the use of strips which check for the presence of blood in for example a toilet bowl.

The disadvantage of these in vitro methods is that you have to collect the sample externally after expulsion of the sample. Problems can arise if for example oral material such as saliva is required, because of the directional requirements of the spitting into a capturing container or directly onto an assessment head. Added to this consumers can be unwilling to provide samples by expectorating because of the inherent messiness and cultural taboos associated with such a process.

This sampling method can also introduce the requirement for the provision of an in vitro sample capturing device into which the sample must be placed along with the detection device, consequently this can complicate the procedure. This method of sampling can introduce the potential for microbial or chemical contamination of the sampled material through its contact with an unsuitable collection means. This may occur if for example the collection means is provided by the user in such a condition that renders it unfit for testing the sample. Similarly, even if the collection means is provided by the test provider, but it is negligently stored by the user this may render it unfit for the testing process leading to inaccurate results.

Test strips for in vivo sampling and detection are known. For example Hemastix® can be used to assess gingivitis by placing these directly on gingival pockets to contact crevicular fluid. These strips must be used by a skilled person such as a Dental Practitioner.

In the in vivo testing environment mentioned, there is the potential for extraneous elements such as for example saliva interfering with the assessment chemicals effectiveness. For example, with the Hemastix®, saliva can contaminate the detector reagents whose chromagen cannot be used in a wet chemistry procedure. There also exists the potential for leaching of the detector chemicals into the in vivo environment in which the assessment is being performed. If this assessment is being carried out for example in the oral cavity this may create an unpleasant or otherwise unwanted taste in the mouth of the recipient. Depending on the chemicals used this method of assessment may even compromise the health of the recipient. Even if the chemical was not released into the oral cavity, due to the provision of a barrier, some users may be unwilling to risk placing such an assessment pad with its associated chemicals into the oral cavity.

### DEFINITION OF THE INVENTION

According to the present invention there is provided a device for the self-assessment of the health of the oral cavity comprising a detector and a sampler located remote from one another on a foldable support, characterised in that the sampler can be contacted with the detector by folding the support, such that a sample can be transferred from the sampler to the detector.

### DETAILED DESCRIPTION OF THE INVENTION

The device according to the present invention can advantageously be utilised in the home of the user. Having collected the sample from the oral cavity the user is not dependent on third parties to test the sample. The user bends or doubles over the flexible device in such a manner so as to contact the sample with the detector. This allows for accurate self-assessment to be carried out quickly and with minimal fuss. Advantageously self-assessment of the health of the oral cavity can be performed by a user who is not a person skilled in oral health care. The user at their convenience can carry out this simple procedure with a single device. It is a cost effective and simplified means for the user to assess the state of health of their oral cavity.

The detector according to the present invention is capable of indicating the health of the oral cavity. The health of the oral cavity may be indicated by the relative presence of blood. Such an indication may be a change in colour or patterning on the detector. Most preferably such an indication comprises chromophores. Preferably they comprise an active such as 3,3′,5,5′-tetramethylbenzidine, 3,3′-dimethylbenzidine (o-Tolidine) or 3,3′-dimethoxydianisidine (o-dianisidine).

Preferably this detector may then be compared with a calibration means such as a colour chart or a pattern chart with a graduated scale. The colour or pattern of the detector after contact with the sample then corresponds to a colour or pattern on the chart, which indicates, for example, the extent of gingivitis. This scale may be tailored to specific groups of people such as smokers who may have a relatively different profile to non-smokers. The calibration means is preferably connected to the device according to the invention.

Most preferably the detector starts yellow/orange and upon contact with haemoglobin change to shades of green or blue depending on the benzidine employed. Test squares with 3,3′,5,5′-tetramethylbenzidine become green. Scattered spots rather than a uniform colour change indicates the presence of intact erythrocytes.

Advantageously from the consumers perspective this colour change from yellow or orange to green or blue removes any negative emotive connotations that may be associated with for example a blood-red indicator indicating the presence of diseases or oral health problems.

The benefit of indicating the health of the oral cavity is that you can note changes to your health status without requiring the input of a skilled person such as a dental practitioner. Therefore having made a quick and easy assessment of the health of the oral cavity, any indication that there may be a problem can be tackled by the user with the appropriate action. For example remedial action such as implementing a more effective oral health care regime can be initiated. Also, continuing assessments as to the effectiveness of otherwise of such a program can be continued by the user, to check for a change in status.

According to another preferred embodiment of the present invention the foldable support comprises a material selected from the group consisting of plastics or plastic-cardboard composites or foil composites. In a more preferred embodiment the foldable support comprises at least one perforated line or is otherwise defined by lines or guides to aid in the folding of this support by the user. The support may be foldable as a result of the material used or as a result of a moveable connector such as a hinge or spring mechanism.

Advantageously the plastics, the plastic cardboard composites and foil composites aid in ensuring that the device is waterproof to varying degrees and it will remain in tact if any fluid sample is contacted with the foldable support. The plastics and foil foldable support ensure that there is no undesired capillary movement of the sample from the sampler to the detector. Also the plastics and foil foldable support ensures that there is no movement of the detector chemicals to the sampler.

According to another embodiment of the present invention the foldable support is a strip. Preferably the strip may be elongate in form.

A benefit of having an elongate strip is that the sampler and the detector can be positioned distant from one another or at opposite ends of the strip. This is advantageous because when collecting the sample, the chemicals on the detector can be kept away from the in vivo sampling environment. Therefore the detector chemicals will be less likely to leak into the oral cavity when sampling. During sampling, the potential for extraneous material in the oral cavity interfering with the detector is non-existent, because they are physically separated. Preferably with an elongate strip a grip portion can be positioned in between the sampler and the detector, aiding the user in the processing of the sample.

The strip according to the invention advantageously allows for the device to be stored in a tubular container and even for a number of devices to be stored in such a container.

According to another preferred embodiment of the present invention the sampler comprises an absorbent material.

The benefit of using an absorbent material is that the user can then place the sampler directly into the oral cavity, and the sample can be collected in a clean and relatively passive or non-taxing manner, that is without the need for expectoration. Using an absorbent material for the sampler also means that during the folding of the device the sample will not be inadvertently spilled from the sampler. This also means that the sample can be collected and stored on the sampler for a period of time before contacting with the detector.

According to another preferred embodiment of the present invention the sampler comprises a material selected from the group consisting of cotton, filter paper, glass wool, glass fibre with acrylic binder, quartz wool, polyurethane foam, fleece or other non-woven materials, rayon, polyesters such as hydro-entangled polyesters or double knit polyesters, and polyester composites such as polyester cellulose composites.

An advantage of using cotton, filter paper, glass wool, glass fibre with acrylic binder, quartz wool, polyurethane foam, fleece, rayon, polyesters, and polyester composites is that these materials allow for different quantities of sample to be collected. The absorbent materials can have different measured capacities to collect certain required amounts of sample.

Different materials also have different affinities for different components and these differing affinities can be utilised to target samples. As a consequence this limits the potential for extraneous material in the oral cavity such as foodstuff debris inadvertently being collected by the absorber and consequently interfering with the detector.

According to another preferred embodiment of the present invention the detector is capable of detecting blood, for example platelets plasma and blood cells including red blood cells and white blood cells. Most preferably the detector is capable of detecting erythrocytes. The erythrocytes may be both in tact, in which case the external constituents of the erythrocytes are detected and not in tact, in which case the components of the erythrocytes such as haemoglobin, haeme, globin and iron are detected.

Preferably the detector is capable of detecting erythrocytes in saliva. Most preferably the reagents in the detector comprise an organic hydroperoxide and a chromophore. Preferably the organic hydroperoxide that is used is cumene hydroperoxide, dimethyl dihydroperoxyhexane or dissopropyl benzene dihydroperoxide. Preferably the detector comprises enough active agent to detect concentrations of haemoglobin as low as 0.15 μg per ml of saliva. The detector reagent detecting these components can be either latent or dried or even one which is ready to use without any activation.

The benefit of detecting blood is that blood in the oral cavity can indicate the presence of gingivitis and as a consequence the early onset of periodontal disease.

Preferably the detector is capable of dispersing a sample from the sampler across its whole width. More preferably this dispersion along the detector is uniform.

According to another aspect of the present invention there is provided the use of a device in the self-assessment of oral cleanliness.

The detection according to the invention can be carried out after brushing the teeth and/or before brushing the teeth. The sampler is placed in the oral cavity for a period of time as determined by the sample to be taken and the sampler utilised. The sampler can remove the sample from various locations or combinations of locations in the oral cavity. These locations may include on or under the tongue or having the sampler licked by the tongue or placing the sampler by the cheek. The sampler is then contacted with the detector for a period of time dependant on the sampler, the sample and the detector used. Then the detector or absorber is exposed so that a self-assessment can be made on the cleanliness of the oral cavity. Preferably this is effected by the presence or absence of blood indicating gingivitis.

According to another aspect of the present invention there is provided a kit of parts comprising a device with an oral composition. Preferably the oral composition may be a dentifrice, gel, foam, lozenge, mouthwash, pastille, or chewing gum.

The benefit of this kit is that it juxtaposes the detection of a problem with an initial means of dealing with and potentially remedying the problem.

According to another aspect of the present invention there is provided a kit of parts comprising a device with a toothbrush.

Preferably the device itself is sealed in a pack which is preferably hermetically sealed to protect the device form light and air which may compromise its effectiveness. The device may also be packaged individually, or in packs with a number of devices in it.

### DRAWING DESCRIPTION

### BRIEF DESCRIPTION OF THE DRAWINGS

The invention shall now be described with reference to the following non-limiting examples.

FIG. 1 is a top plan view of one form of the device according to the invention.

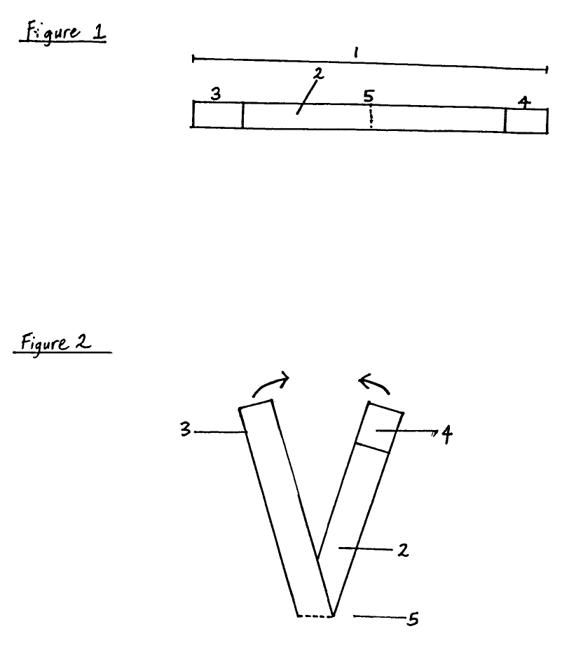

FIG. 2 is a perspective view of one form of the device according to the invention demonstrating the device in the process of being folded.

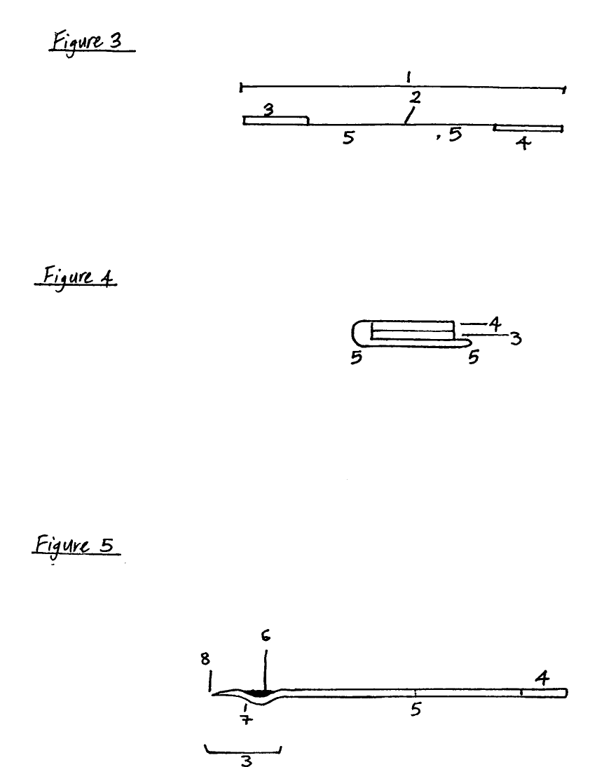

FIG. 3 is a side external view of one form of the device according to the invention.

FIG. 4 is a side external view of one form of the device according to the invention in a folded position.

FIG. 5 is a side external view of one form of the device according to the invention.

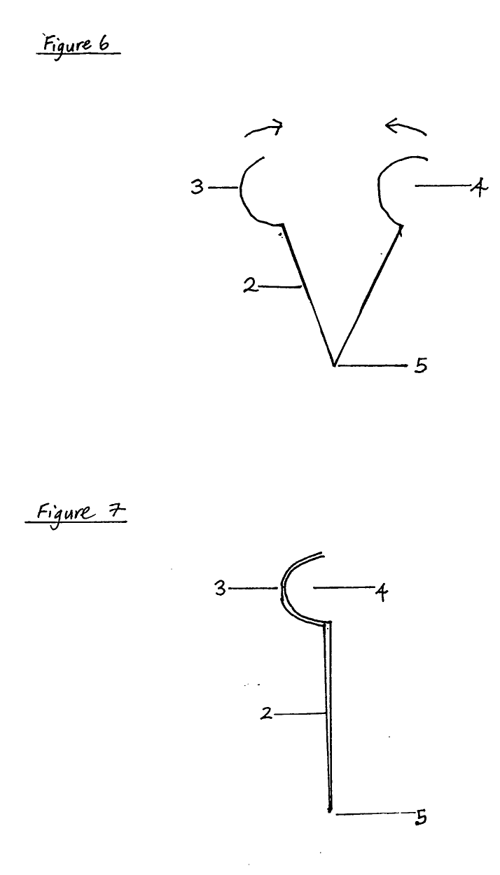

FIG. 6 is a side external view of one form of the device according to the invention.

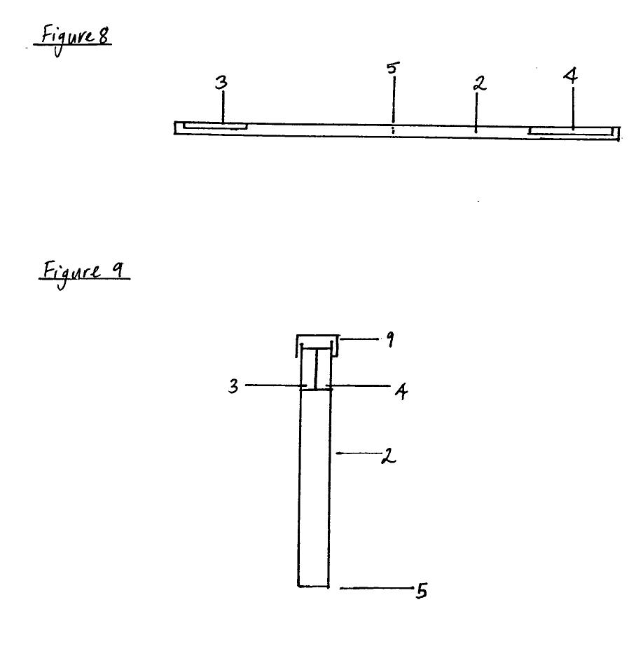

FIG. 7 is a side external view of the device according to FIG. 6 in which the sampler and the detector are contacting.

FIG. 8 is a cross-sectional view of a device according to the invention showing an alternative positioning of the sampler and detector portions.

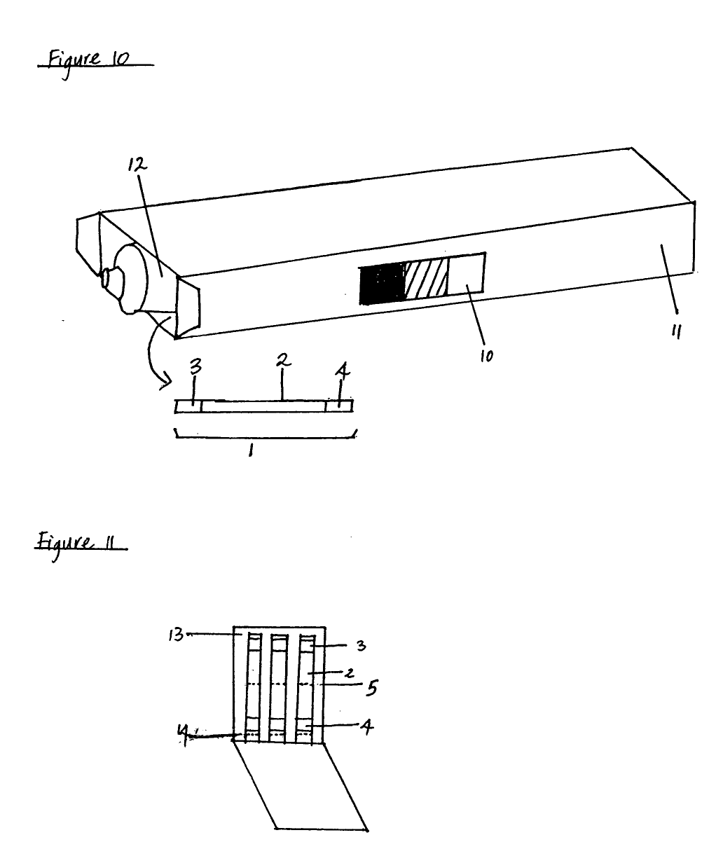

FIG. 9 is a side view of a device according to the invention showing contact between the sampler and the detector and a locking mechanism holding them in this contacted position.

FIG. 10 is a perspective view of a device according to the invention in combination with an oral composition.

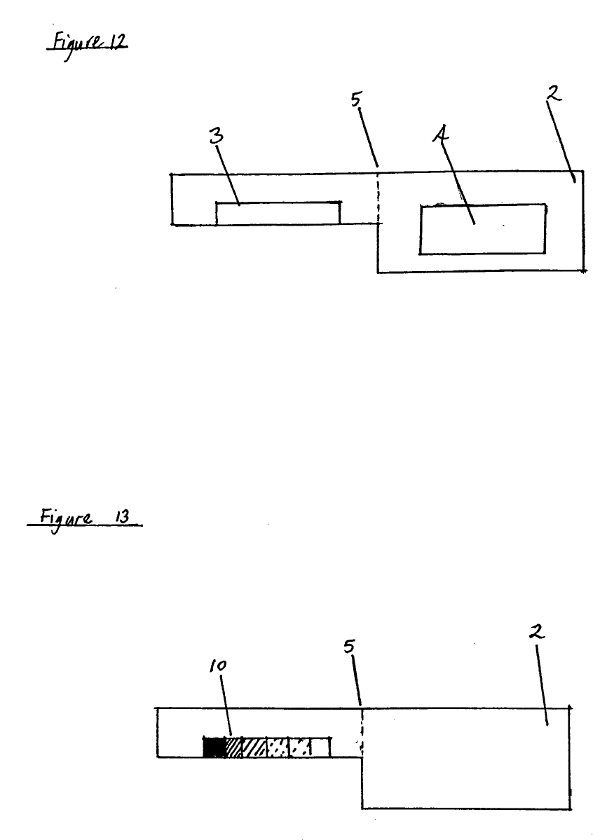

FIG. 11 is a perspective view of a number of devices according to the invention.

FIG. 12 is a perspective view of the front of a device according to the invention.

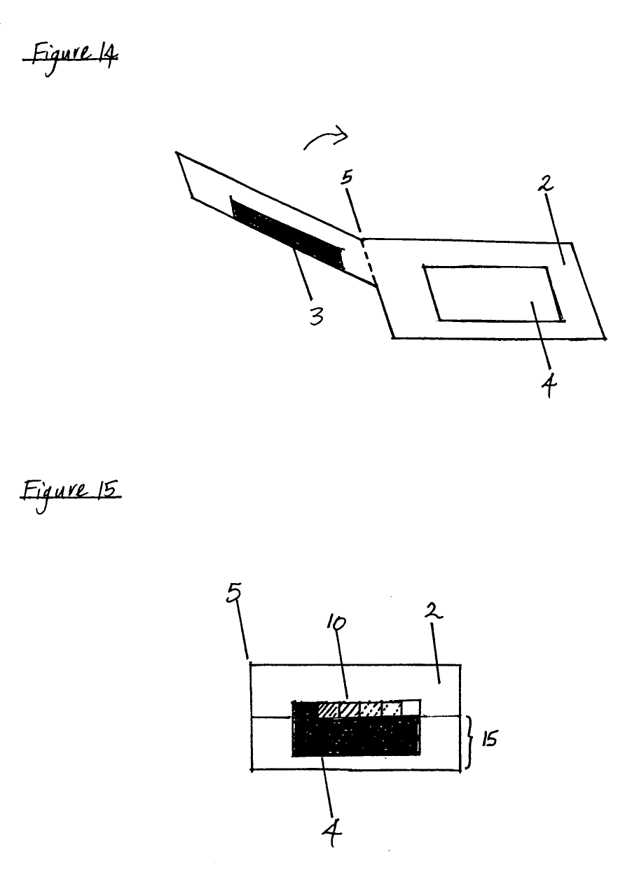

FIG. 13 is a perspective view of the back of the device according to FIG. 12.

FIG. 14 is a perspective view of the device according to FIGS. 12 and 13 demonstrating the device in the process of being folded.

FIG. 15 is a top plan view of the device according to FIGS. 12 to 14 in which the detector and the sampler are in contact.

### DETAILED DESCRIPTION OF THE DRAWINGS

FIG. 1 illustrates a device (1) with a foldable support (2), a sampler (3) and a detector (4). The device (1) has a perforated fold-line (5) which aids in the folding of the device.

FIG. 2 illustrates a device (1) that has been partially folded in the direction illustrated by the arrows. This illustrates how the foldable support (2) can be folded along the fold-line (5) resulting in the sampler (3) at one end of the device moving towards the detector (4) so that they will eventually contact.

FIG. 3 illustrates a device (1) with a foldable support (2), a sampler (3) on one side of the foldable support (2) and a detector (4) on the other side of the foldable support (2). This device has two fold-lines (5) which enable the device to be folded along these fold-lines as illustrated in FIG. 4.

FIG. 4 illustrates how the device in FIG. 4 can be folded along fold-lines (5) in order to contact the sampler (3) with the detector (4) the detector and the sampler being on opposite sides of the support.

FIG. 5 illustrates a device with a sampler (3) in the form of a sample containment region (3), with a sample (6) in the containment region (3) which has been collected by the use of a scoop (7) and a scraper (8). This device also has a detector (4) and a fold-line (5).

FIG. 6 illustrates how the sampler (3) and the detector (4) can be moulded in such a manner that they can co-operate when they contact as demonstrated in FIG. 7.

FIG. 7 illustrates how the sampler (3) and the detector (4) as shown in FIG. 6 can co-operate with one another.

FIG. 8 illustrates the sampler (3) and the detector (4) embedded within the foldable support.

FIG. 9 illustrates the sampler (3) contacting the detector (4) and this contact is held in place by a locking mechanism which is a catch, but could equally be a clasp, latch, clip or glue (9).

FIG. 10 illustrates a packaged toothpaste composition (12) in combination with a device (1) according to the invention. The outer packaging (11) comprises a calibration means (10) with a graduated shade guide, with shades representing several possible diagnoses. This calibration means can be used for comparison with any changes in shade on the detector (4) after contact with sample collected by the sampler (3). The device can be removed from the outer packaging as demonstrated.

FIG. 11 illustrates a sealable pack (13) with a number of devices. These devices are fixed at the detector ends (4) of the devices. They can be removed form this pack by means of a perforated tear-strip (14).

FIG. 12 illustrates a device with a sampler (3), which is smaller in size than the detector (4).

FIG. 13 illustrates the back of FIG. 12 with a calibration means (10) in the form of a graduated shade guide.

FIG. 14 illustrates how once a sample has been captured on the sampler (3) the sampler can be folded along the fold-line (5), in the direction indicated by the arrow in order to move the sampler in the direction of the detector.

FIG. 15 illustrates the sampler contacted with the detector (4) such that the sample is absorbed onto the detector and the sample spreads along the detector such that the graduated shade guide (10) is juxtaposed with the detector. This is made possible by the presence of a window area (15), which enables the detector (4) to remain visible when the device is in a folded position.

What we claim is:

1. A device for the self-assessment of the health of the oral cavity comprising a detector and a sampler located remote from one another on a foldable support, characterised in that the sampler can be contacted with the detector by folding the support, such that a sample can be transferred from the sampler to the detector.

2. A device as claimed in claim 1 in which the foldable support comprises a material selected from the group consisting of plastics, plastic cardboard composites and foil composites.

3. A device as claimed in claim 1 in which the foldable support is a strip.

4. A device as claimed in claim 1 in which the sampler comprises an absorbent material.

5. A device as claimed in claim 1 in which the sampler comprises a material selected from the group consisting of cotton, filter paper, glass wool, glass fibre with acrylic binder, quartz wool, polyurethane foam, fleece, rayon, polyesters, and polyester composites.

6. A device as claimed in claim 1 in which the detector is capable of detecting blood.

7. Use of a device comprising a detector and a sampler located remote from one another on a foldable support, characterised in that the sampler can be contacted with the detector by folding the support, such that a sample can be transferred from the sampler to the detector in the self-assessment of oral cleanliness.

8. Kit of parts comprising a device according to claim 1 with an oral composition.

9. Kit of parts comprising a device according to any of claims 1 with a toothbrush.
